(19) United States
(12) Patent Application Publication
(10) Pub. No.: US 2004/0110915 A1
(43) Pub. Date: Jun. 10, 2004

(54) Low-monomer-content polyisocyanates containing uretdione groups

(76) Inventors: Frank Richter, Leverkusen (DE); Reinhard Halpaap, Odenthal (DE); Hans-Josef Laas, Bergisch Gladbach (DE); Andreas Hecking, Langenfeld (DE)

Correspondence Address: BAYER POLYMERS LLC, 100 BAYER ROAD, PITTSBURGH, PA, 15205, US

(21) Appl. No.: 10/726,359

(22) Filed: Dec. 3, 2003

(30) Foreign Application Priority Data
Dec. 5, 2002 (DE) 10256798.0

(51) Int. Cl. C08G 18/08; C08G 18/22; C08G 18/28; C08G 18/77

(52) U.S. Cl. 528/51; 528/73

(57) ABSTRACT

The invention relates to polyisocyanates which contain uretdione groups, have a particularly low monomer content and are stable towards redissociation and also to their use.

The present patent application claims the right of priority under 35 U.S.C. §119 (a)-(d) of German Patent Application No.102 567 98.0, filed Dec. 5, 2002.

### FIELD OF THE INVENTION

The invention relates to polyisocyanates which contain uretdione groups, have a particularly low monomer content and are stable towards redissociation and also to their use.

### BACKGROUND OF THE INVENTION

Aliphatic polyisocyanates containing uretdione groups and having linear aliphatic substituents on the nitrogen atoms of the four-membered uretdione rings, such as are obtainable, for example, from monomeric hexamethylene diisocyanate (HDI), are low-viscosity products which in low-monomer-content form nevertheless possess the low vapour pressure typical of polyisocyanate resins and are therefore physiologically unobjectionable.

Aliphatic polyisocyanates containing uretdione groups and based on cycloaliphatic monomers, especially isophorone diisocyanate (IPDI), are high-viscosity or solid products whose principal utility is as intermediates for preparing polyurethane powder coating materials.

DE-A 3 030 513 teaches the preparation of polyisocyanates having high uretdione fractions. Tris(dialkylamino)phosphines are used as oligomerization catalysts, alone or in conjunction with cocatalysts (DE-A 3 437 635). Their technical usefulness, however, is hindered by the grave flaw of the high carcinogenic potential of their phosphorus(V) oxides, e.g. hexamethylphosphoric triamide.

DE-A 3 739 549 discloses the catalytic NCO dimerisation with 4-dialkylamino-pyridines, such as 4-dimethylaminopyridine (DMAP), for example, although uretdione is formed selectively only in the case of specific cycloaliphatic isocyanates such as isophorone diisocyanate (IPDI). Linear aliphatic isocyanates such as hexamethylene diisocyanate (HDI) and branched linear aliphatic isocyanates such as trimethylhexane diisocyanate (TMDI) and methylpentane diisocyanate (MPDI) yield primarily strongly coloured, heterogeneous reaction products with DMAP and related compounds.

DE-A 1 670 720 discloses the preparation of aliphatic polyisocyanates containing uretdione groups using as catalysts trialkylphosphines having at least one aliphatic substituent or boron trifluoride and its adducts. The uretdione selectivity of this process, however, is highly dependent on conversion and temperature, so that only at low conversions and reaction temperatures above 50° C. up to a maximum of 80° C. is it possible to obtain high fractions (>50 mol % based on the entirety of the types of structure formed by isocyanate oligomerization) of uretdione groups obtained in the product. Otherwise, isocyanate trimers (isocyanurates and iminooxadiazinediones) and, particularly at higher temperature, other byproducts too, such as carbodiimides or uretonimines, are formed to an increased extent.

In order to limit the conversion in the case of catalysis of tertiary phosphines, alkylating reagents such as dimethyl sulphate (DE-A 1 670 720), methyl toluenesulphonate (EP-A 377 177) or else catalyst poisons such as sulphur (DE-A 19 54 093) are added as stoppers to the active reaction mixture. The deactivated catalysts and/or any stopper used in excess subsequently remain—at least proportionally—in the product and can lead to unwanted properties in the polyisocyanate or in materials and coatings produced from it. Consequently procedures which manage without such stoppers are preferred.

EP-A 337 116 likewise discloses the oligomerization of hexamethylene diisocyanate catalyzed by tributylphosphine using a stopper to limit conversion. When reaction is carried out below 40° C. the polyisocyanate resins containing uretdione groups, following separation of residual monomer, still, however, have a free HDI content of 0.4% by weight. Conversely, if the oligomerization is conducted above 40° C., the HDI content falls to 0.2% by weight. Accordingly the choice of reaction temperatures <40° C. appears unsuitable for the preparation of polyisocyanates containing uretdione groups and having particularly low residual monomer fractions (<0.2% by weight).

DE-A 32 27 779 discloses forming uretdione from 2-methyl-1,5-diisocyanato-pentane/2-ethyl-1,4-diisocyanatobutane mixtures using tri-n-butylphosphine as catalyst at room temperature, although polyisocyanates with a uretdione group content of not more than 30% by weight are obtained.

The prior art processes for isocyanate dimerisation lead to products some of which are very nonuniform in terms of their stability towards redissociation of the four-membered uretdione ring. In the case of storage for weeks or months at temperatures above 40° C. this can lead to decomposition of uretdione groups, which can be manifested in gradually increasing fractions of free, monomeric diisocyanate.

It was therefore an object of the invention to provide a process which can be used not least in industry for preparing isocyanates containing uretdione groups with a residual monomer content lower and a redissociation stability higher than that of polyisocyanates containing uretdione groups and prepared by prior art processes.

### SUMMARY OF THE INVENTION

The present invention is directed to polyisocyanates having a uretdione group content of greater than 50 mol %, based on the entirety of the types of structure formed by isocyanate oligomerization. The residual monomer content of the polyisocyanates is below 0.3% by weight and does not exceed 0.5% by weight after six-months of storage at 50° C.

The present invention is also directed to a process for preparing the above-described polyisocyanates including reacting

a) at least one organic isocyanate at reaction temperatures of −40° C. to +40° C. with a catalyst which comprises at least one trialkylphosphine so that the conversion of the free NCO groups is from 1 to 80% by weight and then

b) separating the active catalyst and any residual, unreacted monomer from the reaction mixture.

The present invention is further directed to a method for producing polyurethane materials, coatings, adhesives and adjuvants including adding the above-described polyisocyanates to a composition that includes a binder.

### DETAILED DESCRIPTION OF THE INVENTION

Other than in the operating examples, or where otherwise indicated, all numbers or expressions referring to quantities of ingredients, reaction conditions, etc. used in the specification and claims are to be understood as modified in all instances by the term “about.”

It has now been found that at temperatures ≦40° C. without using stoppers the oligomerization of isocyanates under catalysis with tertiary phosphines leads to polyisocyanates having a uretdione group content >50 mol % (based on the entirety of the types of structure formed by isocyanate oligomerization), whose residual monomer content is below 0.3% by weight and does not rise above 0.5% by weight even after six-month storage at 50° C.

The invention provides polyisocyanates having a uretdione group content >50 mol %, based on the entirety of the types of structure formed by isocyanate oligomerization, whose residual monomer content is below 0.3% by weight and does not rise above 0.5% by weight even after six-month storage at 50° C.

The invention further provides a process for preparing these polyisocyanates, in which

a) at least one organic isocyanate is reacted at reaction temperatures of ≦+40° C. with a catalyst which comprises at least one trialkylphosphine so that the conversion of the free NCO groups is from 1 to 80% by weight and then

b) the active catalyst and any residual, unreacted monomer are separated from the reaction mixture.

For preparing the polyisocyanates of the invention containing uretdione groups it is possible in principle to use all known organic mono-, di- and/or polyisocyanates prepared by phosgenation or by phosgene-free processes, individually or in any desired mixtures with one another.

Preference is given to using linear aliphatic polyisocyanates having an NCO functionality ≧2 such as pentane diisocyanate, hexane diisocyanate (HDI), heptane diisocyanate, octane diisocyanate, nonane diisocyanate, decane diisocyanate, undecane diisocyanate and dodecane diisocyanate, for example.

Suitable trialkylphosphines for use in accordance with the invention include all tertiary phosphines of the general formula I individually or in any desired mixtures with one another

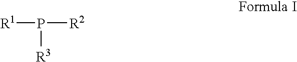

where

R¹, R², R³: independently of one another is a linear or branched aliphatic C₁-C₂₀ radical or a cycloaliphatic C₃-C₂₀ radical optionally substituted one or more times by C₁-C₁₂ alkyl or alkoxy.

Preferably

R¹ is a cyclopropyl, cyclobutyl, cyclopentyl or cyclohexyl radical optionally substituted one or more times by C₁-C₁₂ alkyl,

R², R³ independently of one another are an aliphatic C₂-C₈ alkyl radical or a cyclopropyl, cyclobutyl, cyclopentyl or cyclohexyl radical optionally substituted one or more times by C₁-C₁₂ alkyl.

Examples of phosphines for use in accordance with the invention are trimethylphosphine, triethylphosphine, tripropylphosphine, tributylphosphine, cyclopentyl-dimethylphosphine, pentyl-dimethylphosphine, cyclopentyl-diethylphosphine, pentyl-diethylphosphine, cyclopentyl-di-propylphosphine, pentyl-di-propylphosphine, cyclopentyl-dibutylphosphine, pentyl-dibutylphosphine, cyclopentyl-dihexylphosphine, pentyl-dihexylphosphine, dicyclopentyl-methylphosphine, dipentyl-methylphosphine, dicyclopentyl-ethylphosphine, dipentyl-ethylphosphine, dicyclopentyl-propylphosphine, dipentyl-propylphosphine, dicyclopentyl-butyl-phosphine, dipentyl-butylphosphine, dicyclopentyl-hexylphosphine, dipentyl-hexylphosphine, dicyclopentyl-octylphosphine, dipentyl-octylphosphine, tricyclo-pentylphosphine, tripentylphosphine, cyclohexyl-dimethylphosphine, hexyl-dimethylphosphine, cyclohexyl-diethylphosphine, hexyl-diethylphosphine, cyclohexyl-dipropylphosphine, hexyl-dipropylphosphine, cyclohexyl-dibutyl-phosphine, hexyl-dibutylphosphine, cyclohexyl-dihexylphosphine, hexyl-dihexylphosphine, dicyclohexyl-methylphosphine, dihexyl-methylphosphine, dicyclohexyl-ethylphosphine, dihexyl-ethylphosphine, dicyclohexyl-propyl-phosphine, dihexyl-propylphosphine, dicyclohexyl-butylphosphine, dihexyl-butylphosphine, tricyclohexylphosphine, trihexylphosphine or trioctylphosphine.

The catalyst can be used undiluted or in solution in solvents. Suitable solvents in this case include all compounds which do not react with phosphines, such as aliphatic or aromatic hydrocarbons, alcohols, ketones, esters and ethers, for example. In the process of the invention it is preferred to use the phosphines undiluted.

The amount of catalyst to be used in the process of the invention is guided primarily by the target reaction rate and is situated in the range from 0.01 to 5 mol %, preferably from 0.01 to 3 mol %, based on the sum of the molar amounts of the isocyanate used and of the catalyst. It is most preferred to use from 0.05 to 3 mol % and especially preferred to use 0.05 to 2 mol % of catalyst.

The polyisocyanates of the invention are prepared at temperatures ≦40° C.; it is preferred to choose a temperature of from −40° C. to +40° C., more preferably from 0° C. to +40° C., most preferably from 0° C. to +30° C.

In the process of the invention the conversion of the free NCO groups (resin yield) can vary within wide limits. Preference is given to conversions of from 1 to 80% by weight, more preferably from 5 to 60% by weight, in particular from 5 to 50% by weight.

In order to break off the isocyanate reaction at a desired degree of conversion, the catalyst present in the reaction mixture is separated off preferably by distillation, in particular by way of thin-film distillation.

At the same time as the catalyst is separated off or after it has been separated off, unreacted monomer can be separated off by distillation, for example, from the reaction mixture.

The reaction can be conducted batchwise or continuously. In the case of the continuous procedure the possibly monomer-containing catalyst separated off from the product by distillation is used again in the isocyanate dimerisation.

In addition it is possible at any desired point in time during the preparation of the polyisocyanates of the invention to add stabilizers and additives which are customary in polyisocyanate chemistry. Examples are antioxidants, such as sterically hindered phenols (2,6-di-tert-butylphenol, 4-methyl-2,6-di-tert-butylphenol), light stabilizers, such as HALS amines, triazoles, etc., weak acids or catalysts for the NCO—OH reaction such as dibutyltin dilaurate (DBTL), for example.

Additionally it may be sensible to add small amounts of a prior art alkylating agent or catalyst poison to a worked-up product in order to deactivate catalyst residues, thereby firstly raising the redissociation stability further and secondly reducing the tendency towards formation of byproducts and/or further reaction of the free NCO groups, during product storage, for example.

The polyisocyanates of the invention have an NCO content of from 5 to 27,5% and a free monomer content <0.3% by weight, preferably <0.2% by weight, in particular <0.1% by weight, and this does not rise above 0.5% by weight even after six-month storage at 50° C.

The uretdione group content of the polyisocyanates of the invention, relative to the entirety of the types of structure formed by isocyanate oligomerization, is >50 mol %, preferably >65 mol %.

The invention further provides for the use of the polyisocyanates of the invention for producing polyurethane materials, coatings, adhesives and adjuvants.

If desired the isocyanate groups which are not uretdionized can also be present in blocked form, with all methods known to the skilled worker being suitable for blocking. As blocking agents it is possible in particular to use phenols (e.g. phenol, nonylphenol, cresol), oximes (e.g. butanone oxime, cyclohexanone oxime), lactams (e.g. ε-caprolactam), secondary amines (e.g. diisopropylamine), pyrazoles (e.g. dimethylpyrazole, imidazoles, triazoles) or malonic and acetic esters.

The polyisocyanates of the invention containing uretdione groups can be used in particular for preparing one- and two-component polyurethane coating materials alone or in mixtures with other diisocyanates or polyisocyanates of the prior art, such as diisocyanates or polyisocyanates containing biuret, urethane, allophanate, isocyanurate, and iminooxadiazinedione groups.

Likewise particularly preferred is the use of the polyisocyanates prepared in accordance with the invention on the basis of linear aliphatic isocyanates as reactive diluents to reduce the viscosity of higher viscous polyisocyanate resins.

For the reaction of the polyisocyanates of the invention to give the polyurethane it is possible to use any compounds having at least two isocyanate-reactive functionalities, individually or in any desired mixtures with one another (isocyanate-reactive binder).

Preference is given to using one or more isocyanate-reactive binders known per se in polyurethane chemistry, such as polyhydroxy compounds or polyamines.

Particularly preferred polyhydroxy compounds used are polyester-, polyether-, polyacrylate- and/or polycarboxylic acid-polyols, also where appropriate with the addition of low molecular mass polyhydric alcohols.

The equivalent ratio between non-uretdionized isocyanate group, which where appropriate may also have been blocked, and isocyanate-reactive functionality of the isocyanate-reactive binder, such as OH—, NH— or COOH, for example, is from 0.8 to 3, preferably from 0.8 to 2.

Using an excess of isocyanate-reactive binder is possible, since the dissociation of the uretdione ring, where appropriate at elevated temperature and/or with addition of catalyst, leads to the release of further NCO groups, which are able to react with the excess of isocyanate-reactive functionalities. This raises the network density of the polymer formed and has an advantageous effect on its properties.

For accelerating the crosslinking reaction of the polyisocyanates with the isocyanate-reactive binder it is possible to use any of the catalysts known from polyurethane chemistry. By way of example use may be made of metal salts such as dibutyltin(IV) dilaurate, tin-II-bis(2-ethylhexanoate), bismuth-III-tris(2-ethylhexanoate), zinc-II-bis(2-ethylhexanoate) or zinc chloride and also tertiary amines such as 1,4-diazabicyclo(2.2.2)octane, triethylamine or benzyldimethylamine.

In the context of the formulation the optionally blocked polyisocyanate of the invention, the isocyanate-reactive binder, catalyst(s) and, where used, the customary additions such as pigments, fillers, additives, levelling assistants, defoamers and/or dulling agents are mixed with one another and homogenized on a customary mixing unit such as a sand mill, for example, optionally with the use of solvents.

Suitable solvents include all customary paint solvents known per se, such as ethyl and butyl acetate, ethylene or propylene glycol monomethyl, monoethyl or monopropyl ether acetate, 2-butanone, 4-methyl-2-pentanone, cyclohexanone, toluene, xylene, solvent naphtha, N-methylpyrrolidone, etc.

The coating materials can be applied in solution or from the melt and also, where appropriate, in solid form (powder coating materials) by the customary methods such as brushing, rolling, pouring, spraying, dipping, the fluid-bed sintering method or by electrostatic spraying methods to the article that is to be coated.

The invention further provides substrates coated with coatings produced from the polyisocyanates of the invention.

Suitable substrates include all known materials, especially metals, wood, plastics and ceramic.

### EXAMPLES

All percentages, unless noted otherwise, are to be understood as percent by weight (% by weight).

A temperature stated as room temperature is understood to be 23±3° C.

The NCO content of the resins described in the inventive and comparative examples is determined by titration in accordance with DIN 53 185.

The monomer contents were determined by gas chromatography in accordance with DIN 55 956.

The dynamic viscosities were determined at 23° C. using a rotational viscometer (ViscoTester® 550, Thermo Haake GmbH, D-76227 Karlsruhe). Measurements were carried out at different shear rates to ensure that the flow behaviour of the polyisocyanates described, prepared in accordance with the invention, and that of the comparison products corresponds to that of ideal Newtonian fluids. It is therefore unnecessary to state the shear rate.

The indication ‘mol %’ or indication of the molar ratio of different types of structure to one another is based on NMR spectroscopy measurements. Unless otherwise specified it refers to the sum of the types of structure formed by the modification reaction (oligomerization) from the hitherto free NCO groups of the isocyanate being modified. The ¹³C-NMR measurements were made on the Bruker instruments DPX 400, AVC 400 and DRX 700 on approximately 50% strength samples in dry CDCl₃ at a proton frequency of 400 or 700 MHz (¹³C-NMR: 100 or 176 MHz, relaxation delay: 4 sec, 2000 scans). The reference chosen for the ppm scale was small amounts of tetramethylsilane in the solvent, with a ¹³C chemical shift of 0 ppm, or the solvent itself, with a shift of 77.0 ppm (CDCl₃).

### Example 1 (Comparative)

TABLE 1
Reaction parameters

| Example | Catalyst | Temperature |
|---|---|---|
| 1a | 10 g tris(diethylamino)phosphine | 60° C. |
| 1b | 1.5 g tributylphosphine | 60° C. |

1a: Comparative to DE-A 32 27 779
1b: Comparative to DE-A 16 70 720

1000 g in each case of freshly distilled, degassed HDI were admixed under nitrogen with the catalyst indicated in Table 1 and the reaction mixture was stirred at 60° C. until its refractive index (at 20° C. and the frequency of the light of the D line of the sodium spectrum, n_{D}²⁰) was approximately 1.4600 to 1.4650 (start=no conversion=n_{D}²⁰ of the pure HDI=1.4523). It was subsequently worked up in a thin-film evaporator, of the short-path evaporator (SPE) type, with upstream pre-evaporator (PE) at a heating medium temperature of 140° C. (PE) and 150° C. (SPE) respectively and at a vacuum of from 0.1 to 0.5 mbar, with unreacted monomer and the active catalyst being separated off. The distillate was topped up to 1000 g with fresh degassed HDI, stirred again under the reaction conditions indicated above, without the addition of further catalyst, under nitrogen until the above-mentioned refractive index range of approximately 1.4600 to 1.4650 was reached, at which point it was worked up as described. This procedure was repeated a total of 2 times more, so that for each catalyst the polyisocyanate resins 1-4 were obtained (table 2).

The products were subsequently stored at 50° C. and the residual monomer content was monitored over a period of six months (table 3).

TABLE 2
Product properties from Example 1

| | | | | | Free HDI | |
|---|---|---|---|---|---|---|
| Ex- | n_{D}²⁰ at | Resin | NCO | | after | |
| am- | start of | amount | content | Viscosity | distillation | Uretdiones |
| ple | distillation | [g] | [%] | [mPas] | [%] | [mol %] |
| 1a-1 | 1.4646 | 395 | 20.8 | 55 | 0.46 | 99 |
| 1a-2 | 1.4651 | 375 | 21.1 | 67 | 0.45 | 97 |
| 1a-3 | 1.4638 | 326 | 21.4 | 66 | 0.62 | 97 |
| 1a-4 | 1.4623 | 329 | 22.7 | 50 | 0.74 | 98 |
| 1b-1 | 1.4650 | 271 | 22.0 | 130 | 0.08 | 76 |
| 1b-2 | 1.4619 | 260 | 22.4 | 110 | 0.09 | 77 |
| 1b-3 | 1.4600 | 202 | 23.3 | 76 | 0.08 | 78 |
| 1b-4 | 1.4625 | 276 | 22.7 | 94 | 0.09 | 80 |

TABLE 3
Amount of free HDI in [%] after storage at 50° C.

| | | After | After | After | After |
|---|---|---|---|---|---|
| Example | Start | 1 month | 2 months | 4 months | 6 months |
| 1a-1 | 0.46 | 0.65 | 0.72 | 0.76 | 0.84 |
| 1a-2 | 0.45 | 0.54 | 0.55 | 0.58 | 0.61 |
| 1a-3 | 0.62 | 0.58 | 0.64 | 0.65 | 0.67 |
| 1a-4 | 0.74 | 0.78 | 0.82 | 0.93 | 1.00 |
| 1b-1 | 0.08 | 0.37 | 0.43 | 0.59 | 0.68 |
| 1b-2 | 0.09 | 0.43 | 0.51 | 0.68 | 0.84 |
| 1b-3 | 0.08 | 0.55 | 0.66 | 0.84 | 1.11 |
| 1b-4 | 0.09 | 0.43 | 0.52 | 0.68 | 0.89 |

As can be seen, using the potentially carcinogenic catalyst P(NEt₂)₃ produces resins with a high redissociation stability but a poor initial monomer content, whereas using tributylphosphine does produce resins having a very low initial monomer content but these resins have a strong tendency towards redissociation within a few weeks of storage at 50° C.

### Example 2

A procedure analogous to that of Example 1 was carried out with the following catalysts and temperatures

TABLE 4
Reaction parameters

| Example | Catalyst | Temperature |
|---|---|---|
| 2a | 1.5 g tributylphosphine | room temperature |
| 2b | 2.5 g cyclohexyl-di-n-hexylphosphine | room temperature |
| 2c | 2.5 g cyclohexyl-di-n-hexylphosphine | 60° C. |
| (comparative) | | |
| 2d | 2.5 g cyclohexyl-di-n-hexylphosphine | 80° C. |
| (comparative) | | |

Workup and analyses take place as indicated in Example 1. The data are set out in Tables 5 and 6.

TABLE 5
Product properties from Example 2

| | | | | | Free HDI | |
|---|---|---|---|---|---|---|
| Ex- | n_{D}²⁰ at | Resin | NCO | | after | |
| am- | start of | amount | content | Viscosity | distillation | Uretdiones |
| ple | distillation | [g] | [%] | [mPas] | [%] | [mol %] |
| 2a-1 | 1.4579 | 152 | 23.9 | 106 | 0.08 | 74 |
| 2a-2 | 1.4612 | 238 | 23.1 | 156 | 0.06 | 72 |
| 2a-3 | 1.4614 | 241 | 22.9 | 125 | 0.06 | 71 |
| 2a-4 | 1.4728 | 449 | 20.7 | 330 | 0.04 | 67 |
| 2b-1 | 1.4632 | 255 | 22.5 | 175 | 0.06 | 71 |
| 2b-2 | 1.4584 | 124 | 23.5 | 119 | 0.08 | 71 |
| 2b-3 | 1.4628 | 223 | 22.5 | 160 | 0.07 | 71 |
| 2b-4 | 1.4634 | 235 | 22.4 | 160 | 0.06 | 69 |
| 2c-1 | 1.4668 | 306 | 21.3 | 195 | 0.08 | 74 |
| 2c-2 | 1.4655 | 301 | 21.7 | 163 | 0.06 | 75 |
| 2c-3 | 1.4626 | 273 | 22.1 | 126 | 0.08 | 78 |
| 2c-4 | 1.4618 | 220 | 22.3 | 83 | 0.06 | 79 |
| 2d-1 | 1.4640 | 301 | 22.6 | 97 | 0.17 | 79 |
| 2d-2 | 1.4699 | 325 | 21.3 | 215 | 0.15 | 77 |
| 2d-3 | 1.4664 | 320 | 21.9 | 145 | 0.14 | 74 |
| 2d-4 | 1.4655 | 347 | 22.1 | 141 | 0.14 | 73 |

TABLE 6
Amount of free HDI in [%] after storage at 50° C.

| Example | Start | After 1 month | After 6 months |
|---|---|---|---|
| 2a-1 | 0.08 | 0.14 | 0.26 |
| 2a-2 | 0.06 | 0.18 | 0.29 |
| 2a-3 | 0.06 | 0.16 | 0.28 |
| 2a-4 | 0.04 | 0.12 | 0.24 |
| 2b-1 | 0.06 | 0.16 | 0.28 |
| 2b-2 | 0.08 | 0.24 | 0.43 |
| 2b-3 | 0.07 | 0.24 | 0.39 |
| 2b-4 | 0.06 | 0.17 | 0.32 |
| 2c-1 | 0.08 | 0.46 | 0.62 |
| 2c-2 | 0.06 | 0.49 | 0.66 |
| 2c-3 | 0.08 | 0.53 | 0.73 |
| 2c-4 | 0.06 | 0.35 | 0.59 |
| 2d-1 | 0.17 | 0.66 | 0.88 |
| 2d-2 | 0.15 | 0.84 | 1.01 |
| 2d-3 | 0.14 | 0.86 | 0.88 |
| 2d-4 | 0.14 | 0.96 | 1.25 |

The resins prepared at ambient temperature in accordance with the invention (Examples 2a and 2b) have residual monomer contents <0.5% by weight even after six-month thermal exposure whereas the resins of the comparative experiments, prepared at a higher reaction temperature (comparative Examples 2c and 2d), have a greater redissociation tendency.

### Example 3 (Inventive)

The isocyanate oligomerization and the workup were conducted in analogy to the procedure in Example 1.

| Catalyst | Temperature |
|---|---|
| 13 g n-butyl-dicyclopentylphosphine | 40° C. |

TABLE 7
Product properties from Example 3

| | | | | | Free HDI | |
|---|---|---|---|---|---|---|
| Ex- | n_{D}²⁰ at | Resin | NCO | | after | |
| am- | start of | amount | content | Viscosity | distillation | Uretdiones |
| ple | distillation | [g] | [%] | [mPas] | [%] | [mol %] |
| 3-1 | 1.4694 | 440 | 20.9 | 125 | 0.09 | 81 |
| 3-2 | 1.4694 | 430 | 20.6 | 132 | 0.06 | 80 |
| 3-3 | 1.4696 | 410 | 20.8 | 140 | 0.06 | 81 |
| 3-4 | 1.4696 | 390 | 20.9 | 127 | 0.04 | 81 |

TABLE 8
Amount of free HDI in [%] after storage at 50° C.

| Example | Start | 6 months |
|---|---|---|
| 3-1 | 0.09 | 0.42 |
| 3-2 | 0.06 | 0.38 |
| 3-3 | 0.06 | 0.40 |
| 3-4 | 0.04 | 0.36 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Polyisocyanates having a uretdione group content of greater than 50 mol %, based on the entirety of the types of structure formed by isocyanate oligomerization, wherein the residual monomer content is below 0.3% by weight and does not exceed 0.5% by weight after six-month storage at 50° C.

2. A process for preparing the polyisocyanates of claim 1, comprising reacting
c) at least one organic isocyanate at reaction temperatures of ≦+40° C. with a catalyst which comprises at least one trialkylphosphine so that the conversion of the free NCO groups is from 1 to 80% by weight and then
d) separating the active catalyst and any residual, unreacted monomer from the reaction mixture.

3. A method for producing polyurethane materials, coatings, adhesives and adjuvants comprising adding the polyisocyanates of claim 1 to a composition comprising a binder.

4. Substrates coated with coatings of claim 3.

5. The process of claim 2, wherein the trialkylphosphine is selected from the group consisting of trimethylphosphine, triethylphosphine, tripropylphosphine, tributylphosphine, cyclopentyl-dimethylphosphine, pentyl-dimethylphosphine, cyclopentyl-diethylphosphine, pentyl-diethylphosphine, cyclopentyl-di-propylphosphine, pentyl-di-propylphosphine, cyclopentyl-dibutylphosphine, pentyl-dibutylphosphine, cyclopentyl-dihexylphosphine, pentyl-dihexylphosphine, dicyclopentyl-methylphosphine, dipentyl-methylphosphine, dicyclopentyl-ethylphosphine, dipentyl-ethylphosphine, dicyclopentyl-propylphosphine, dipentyl-propylphosphine, dicyclopentyl-butylphosphine, dipentyl-butylphosphine, dicyclopentyl-hexylphosphine, dipentyl-hexylphosphine, dicyclopentyl-octylphosphine, dipentyl-octylphosphine, tricyclopentylphosphine, tripentylphosphine, cyclohexyl-dimethylphosphine, hexyl-dimethylphosphine, cyclohexyl-diethylphosphine, hexyl-diethylphosphine, cyclohexyl-dipropylphosphine, hexyl-dipropylphosphine, cyclohexyl-dibutylphosphine, hexyl-dibutylphosphine, cyclohexyl-dihexylphosphine, hexyl-dihexylphosphine, dicyclohexyl-methylphosphine, dihexyl-methylphosphine, dicyclohexyl-ethylphosphine, dihexyl-ethylphosphine, dicyclohexyl-propylphosphine, dihexyl-propylphosphine, dicyclohexyl-butylphosphine, dihexyl-butylphosphine, tricyclohexylphosphine, trihexylphosphine and trioctylphosphine.
